(19) United States
(12) Patent Application Publication
(10) Pub. No.: US 2007/0080544 A1
(43) Pub. Date: Apr. 12, 2007

(54) Coast to coast 4-N-1 gate latch

(76) Inventors: George W. Pachello, Lakewood, CO (US); Victor D. Vandamme, Littleton, CO (US)

Correspondence Address: GEORGE PACHELLO, 2125 GARLAND, LAKEWOOD, CO, 80215, US

(21) Appl. No.: 11/247,905

(22) Filed: Oct. 12, 2005

(51) Int. Cl. E05C 3/14

(52) U.S. Cl. 292/228

(57) ABSTRACT

A gate latch includes a gate latch assembly and a striker bar. The striker bar is attached to a gate post or gate frame. The latch assembly is attached to a gate post or gate frame. The handles of the latch assembly are perpendicular to the latch striker plate. The striker plate notch is angled so as to allow for gate sagging and hinge wear. The latch assembly includes an activator design which allows for smooth operation. The activator is manufactured from a nylon material allowing for longer life of the latch.

### BACKGROUND OF THE INVENTION

1. Field of the Invention

The present invention relates generally to latches and more specifically to a gate latch, with convenient handles and a latch which allows for hinge wear and gate sag while allowing the gate to be held securely.

2. Discussion of the Prior Art

It appears that no gate latch exists with handles perpendicular to the latch assembly or a gate latch with any type of activator protruding from the handle such that the handle does not come in contact with the striker bar. Further, it appears that existing gate latches will fail to latch and hold the gate securely as normal wear in the gate hinges and/or gate sagging occurs. In addition it appears that no chain link style gate latch exists with handles perpendicular to the latch assembly or a gate latch with any type of activator protruding from the handle such that the handle does not come in contact with the striker bar.

Therefore, a need in the art exists for a gate latch with handles that can be operated by all users, especially those with limited dexterity. A need also exists for a latch design that compensates for gate sagging and/or hinge wear, that will hold the gate securely in place.

### BRIEF DESCRIPTION OF THE DRAWINGS

FIG. 1 is a front plan view of the gate latch in accordance with the present invention. FIG. 1 depicts the striker bar as totally surrounded by the activator, and striker plate.

FIG. 2 is a front plan view of the striker plate with the following item descriptions:

Item 1: mounting holes depending on the type and size of material, i.e. wood or metal, 2×4, or 4×4 wood.

Item 2: holes to allow for a variety of locks.

Item 3: holes to allow for attaching a return spring and adjustment of the return spring.

Item 4: The notch in the striker plate to receive the striker bar.

The angle of the notch is designed to allow for gate sag, while maintaining the gate in a secure position.

Item 5: Alignment pins or punched tabs from the striker plate to be used to mount the striker plate.

Item 6: Punched tabs from the striker plate or dowel pin holes to be used as stops to limit the travel of the latch.

Item 7: Mounting hole in the center of the striker plate to attach the latch and handle assembly.

Item 8: Multiple holes to receive U-Bolts and allow mounting of striker plate to a variety of chain link fence posts.

FIG. 3 is a perspective view of the gate latch assembly with the handle and attached Activator in a bold linetype.

FIG. 4 is a perspective view of the gate latch assembly with the washers in a bold linetype.

FIG. 5 is a perspective view of the gate latch assembly with two options for return springs in a bold linetype.

FIG. 6 is a perspective view of the gate latch assembly with the shoulder bolt in a bold linetype.

FIG. 7 is a perspective view of the gate latch assembly with the striker plate in a bold linetype.

FIG. 8 is a perspective view of the gate latch assembly with a straight striker bar.

FIG. 9 is a perspective view of the gate latch assembly with a 90 degree striker bar mounted on a wood or metal fence.

FIG. 10 is a perspective view of the gate latch assembly mounted on a chain link fence style gate with a straight striker bar.

FIG. 11 is a perspective view of the gate latch assembly mounted on a chain link fence style gate with a 90 degree striker bar.

FIG. 12 is a perspective view of the gate latch assembly mounted on a chain link fence style gate with a straight striker bar mounted with U-bolt style clamp.

FIG. 13 is a perspective view of a straight striker bar and 90 degree bar that are to mounted directly to a wood or metal fence post and a threaded straight and 90 degree striker bars to be mounted through a wood or metal post with a threaded nut.

### DETAILED DESCRIPTION OF THE PREFERRED EMBODIMENTS

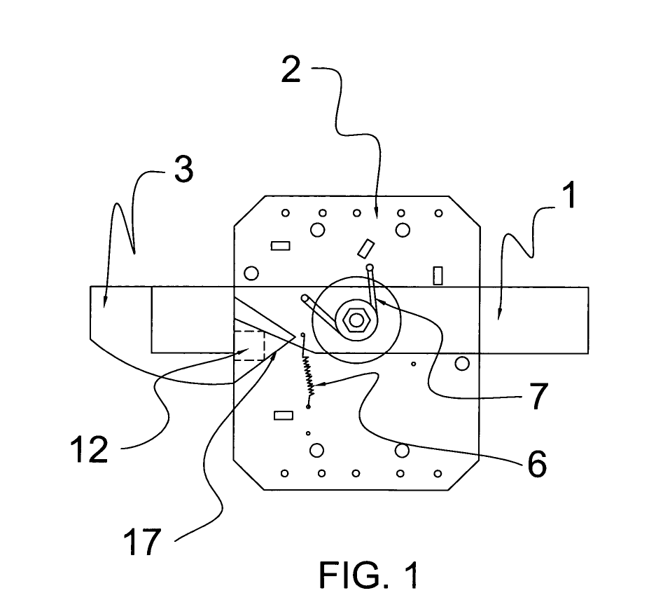

With reference now to the drawings, and particularly to FIG. 1, there is shown a perspective view of the gate latch assembly. The latch assembly is comprised of a striker plate 2, a handle 1 with an activator 3 attached to the handle 1. A spring 7 is used to hold the handle 1 against the striker plate 2 and a spring 6 is used to return the activator 3 to a latched position. In closing the gate with the latch assembly, the activator 3 rides over a square striker bar 12 and the striker bar 12 is captured by the vertical edge of the activator 3 and the V notch 17 on the striker plate 2.

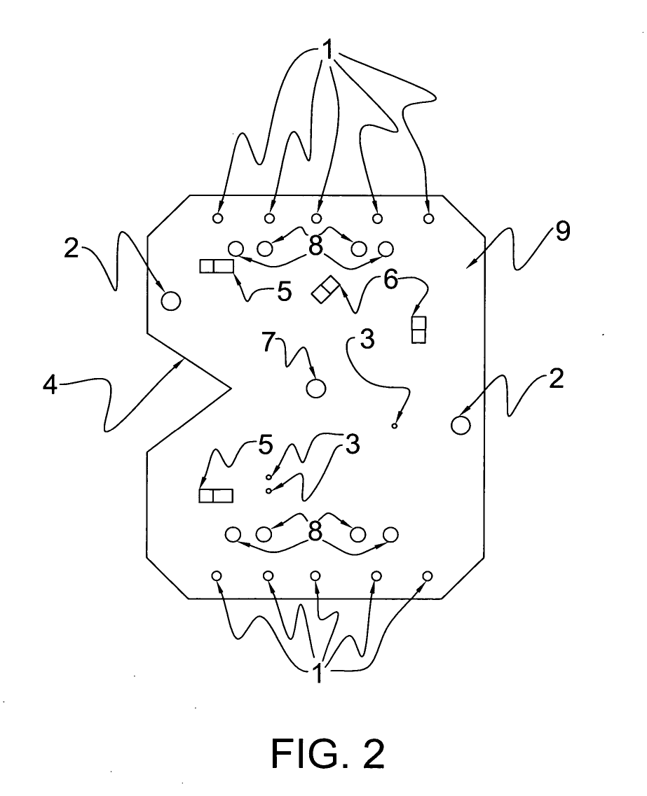

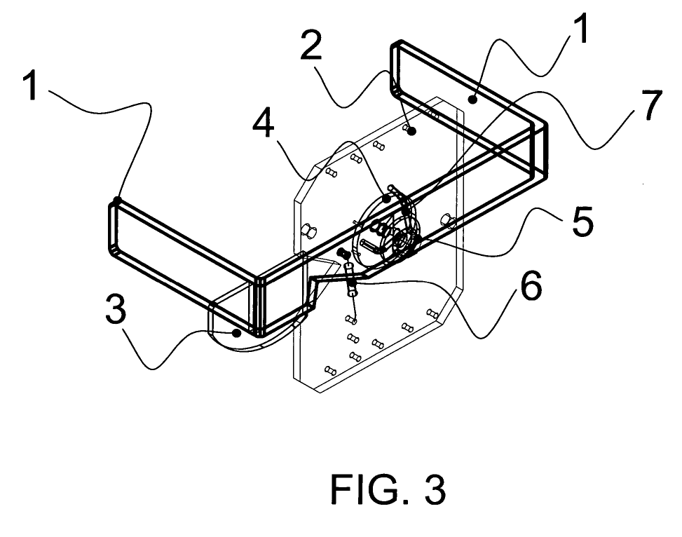

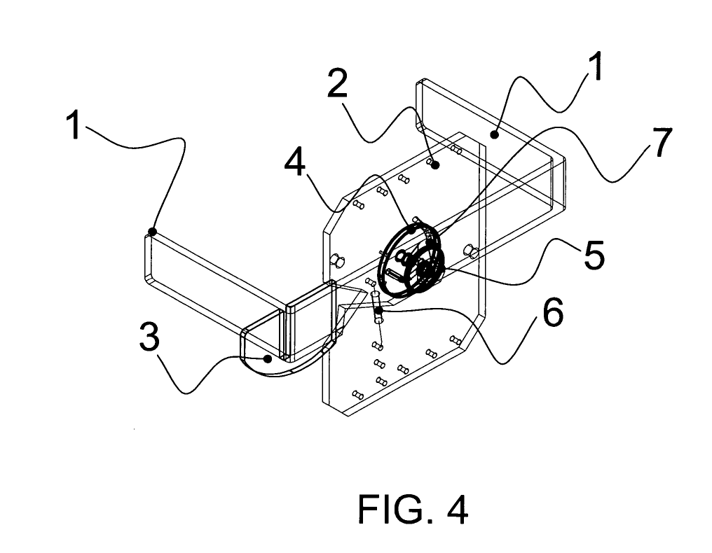

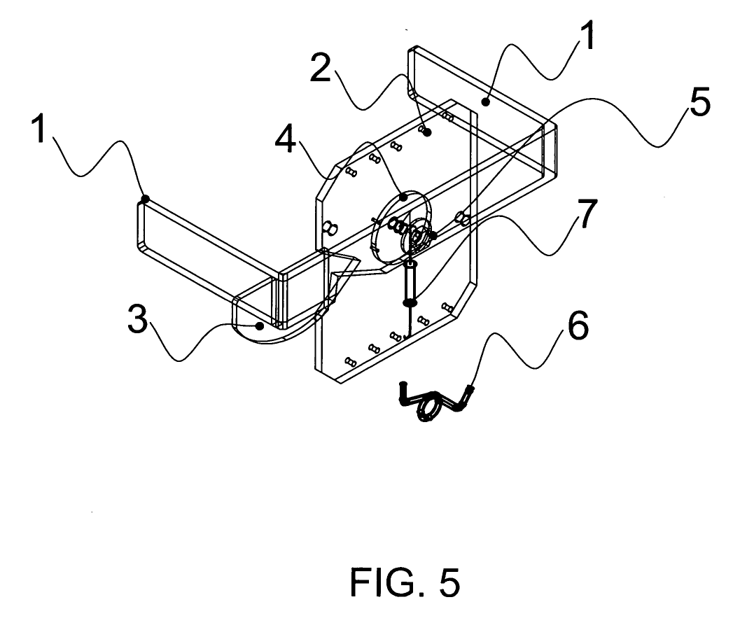

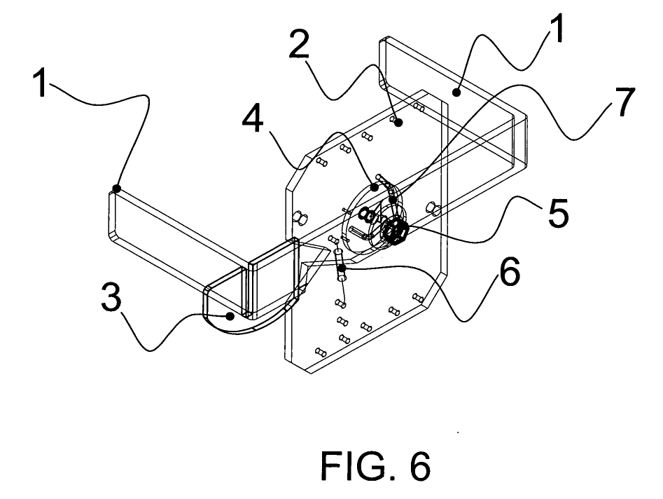

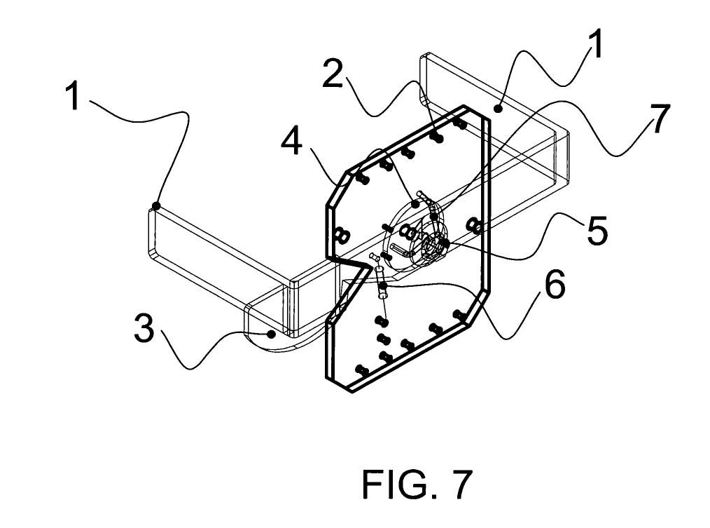

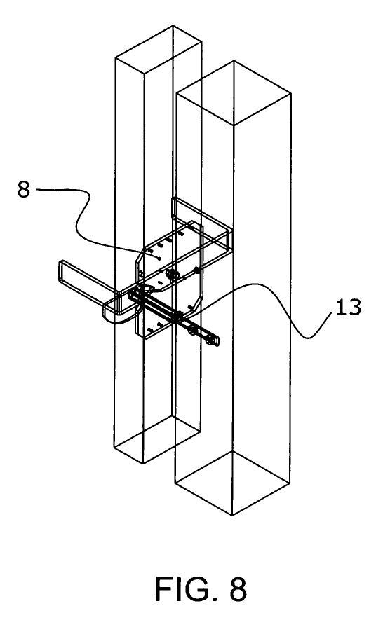

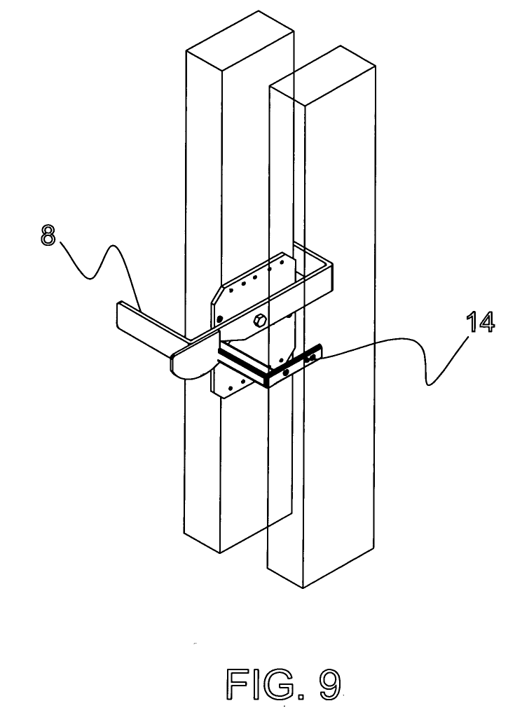

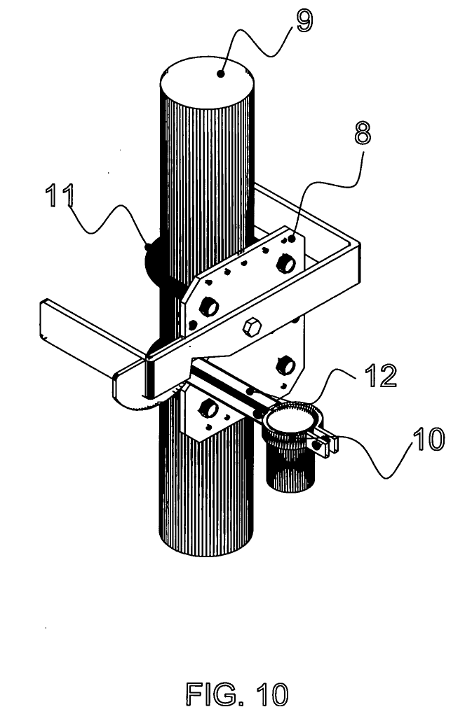

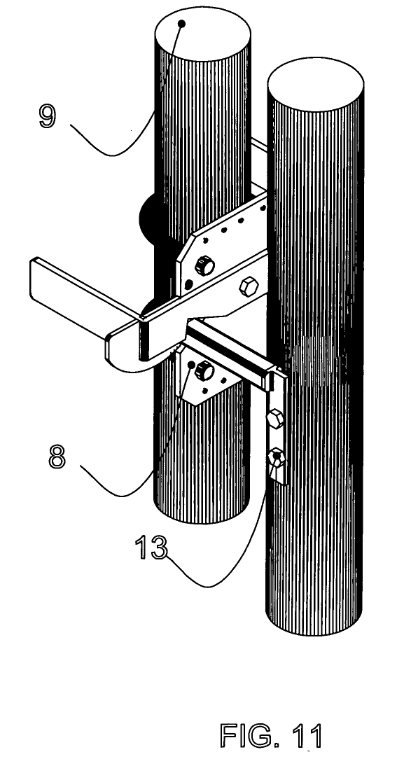

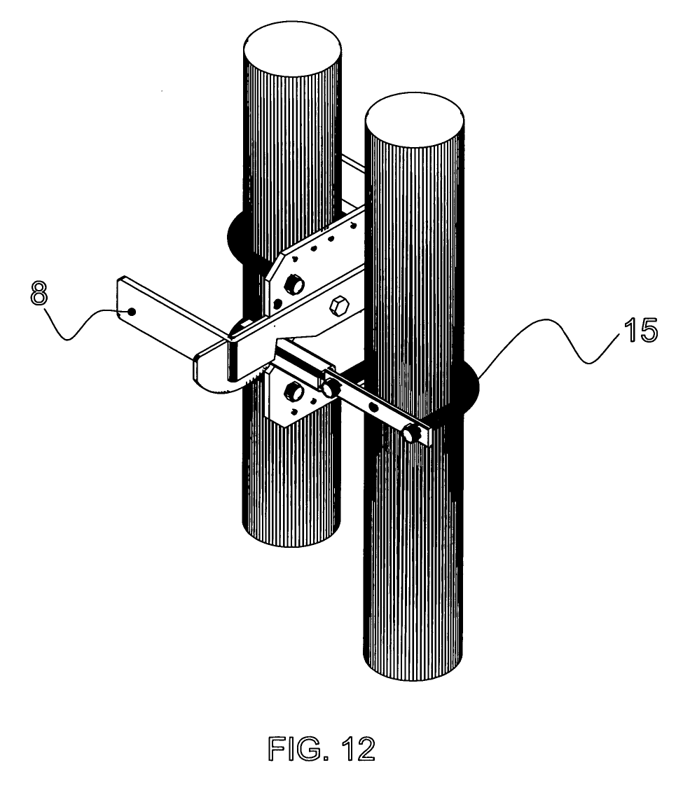

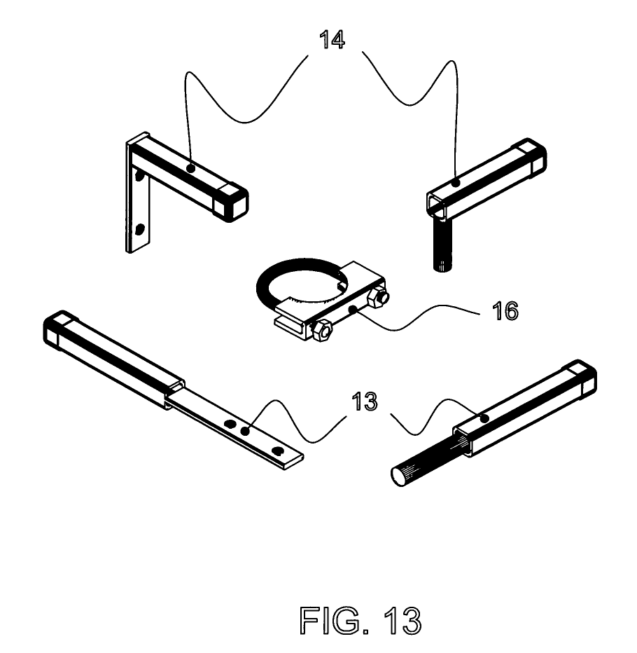

With reference to FIG. 2, a perspective view of the striker plate 9 is depicted with the following features: items 1 are a several holes used to mount the latch assembly to a wood or metal fence post. Items 2 are holes used to allow for key or combination locks to lock the gate latch assembly. Items 3 are holes used to attach a return spring and allow for adjustment of the return spring. Item 4 is the notch or “V” in the striker plate to receive the striker bar. The angle of the notch is designed to allow for gate sag, while maintaining the gate in a secure position. Item 5 alignment pins or punched tabs from the striker plate to be used to mount the striker plate.

Items 6 are punched tabs from the striker plate or dowel pin holes to be used as stops to limit the travel of the latch handle. Item 7 is the hole in the center of the striker plate to attach the handle and striker plate assembly. Items 8 are holes to receive U-Bolts and allow mounting of the striker plate to a chain link fence.

With reference to FIGS. 3-7, the latch assembly is made of the striker plate 2 mounted to the handle 1 and the activator 3. These three embodiments are secured by washers 4 and a shoulder bolt 5. A return spring 6 is used to return the handle 1 and activator 3 to a latched position. A spring 7 is used to allow for movement in the handle 1 mounted to the striker plate 2. The handle 1 lifted up on one side of the fence to allow for opening of the gate and the handle 1 is pushed down on the opposite side of the fence to allow for opening of the gate. In FIGS. 3-7 each part is shown in a bold linetype.

With reference to FIG. 8, is a perspective view of the latch assembly 8 mounted to a wooden or metal fence post with a straight striker bar 13.

With reference to FIG. 9, is a perspective view of the gate latch assembly 8 with a 90 degree striker bar 14 mounted on a wood or metal fence.

With reference to FIG. 10, the gate latch assembly 8 is mounted to a chain link fence gate 9 with a U-Bolt 11. A straight striker bar 12 is mounted with a clamp 10.

With reference to FIG. 11, the gate latch assembly 8 is mounted to a chain link fence gate 9 with a 90 degree striker bar 13 mounted to a chain link fence post with threaded fasteners.

With reference to FIG. 12, the gate latch assembly 8 is mounted to a chain link fence gate with a straight striker bar and U-Bolt 15

With reference to FIG. 13, 90 degree striker bars 14 are depicted with bolt holes and threaded shaft for mounting. Straight striker bars 13

are depicted with bolt holes and threaded shaft for mounting. A spacer clamp 16 is used to mount the striker plate to chain link fence gate.

1. A gate latch comprising a square striker bar. A latch frame including inside and outside handles.

2. An Activator on the inside handle to receive a striker bar of square tubing.

3. The Activator is designed with a protrusion from the handle such that there will be contact with the striker bar before the handle and raise the latch due to a common center point.

4. The long radius of the Activator provides a ramping action which is quicker, smoother and lifts the latch with less leverage than prior art.

5. The ramping action of the Activator compensates for up and down gate movement.

6. An angled notch on the striker plate to receive a square striker bar.

7. The Activator working together with the angled notch to hold the striker bar secure. The specific angled notch is designed to hold the gate secure after gate sag and/or wear in the gate hinges has occurred. The angle will “lift” or “lower” the gate after wear or sagging occurs.

8. The weight of the Activator and Handle will cause the latch to remain in a closed or latched position.

9. The gate latch with inside and outside handles are secured by a shoulder bolt and two washers. The shoulder bolt shall be threaded or pressed into the latch assembly. There shall exist a machined surface on the shoulder bolt for longer life. Said shoulder bolt and two washers allow for increased handle stabilization and increased life of the gate latch.

10. The handles provide increased surface area to grasp in a more natural position, with one motion, and allow for increased leverage.

11. The handles are parallel to the operator's body, offering no protrusions, and providing for safer use.

12. The handles allow for a small clearance between gate and fence of 0.25 inches. This tighter fit provides for a more secure gate.

13. The weight of the Handle and Activator will cause the latch to remain in a closed or latched position.

14. The two washers shall rest on both sides of latch handle. The two washers will be made from nylon material to prevent rusting and reduce noise.

15. For normal security a straight striker bar shall be in place.

16. For increased security a 90 Degree striker bar shall be in place

17. The Angle on the latch handle sets the depth necessary for the two parallel surfaces to secure the gate latch, provides maximum locking power and closes the opening between the latch and striker plate as shown in FIG. 1.

18. The striker plate will have several mounting holes to allow for use with wood and metal gates that utilize square or rectangular posts.

19. The striker plate will shall allow for use with chain link style gates and fences.

20. A type of coil spring will be used to return the latch to a latched and normally horizontal position and secure the gate in a locked position

21. A straight spring is positioned in front of the pivot point on the downward side of travel to allow the latch to return to a closed position.
